(19) United States
(12) Patent Application Publication
(10) Pub. No.: US 2024/0232657 A9
(43) Pub. Date: Jul. 11, 2024

(54) LIFE PREDICTION METHOD OF ROTARY MULTI-COMPONENT SYSTEM AND RELATED APPARATUS

(71) Applicant: GUANGDONG UNIVERSITY OF TECHNOLOGY, Guangzhou (CN)

(72) Inventors: Yaohua DENG, Guangzhou (CN); Hao HUANG, Guangzhou (CN); Xiali LIU, Guangzhou (CN)

(21) Appl. No.: 18/323,492

(22) Filed: May 25, 2023

(30) Foreign Application Priority Data
Oct. 24, 2022 (CN) 202211299117.5

(51) Int. Cl. G06N 5/022

(52) U.S. Cl. CPC G06N 5/022

(57) ABSTRACT

Disclosed are a life prediction method of a rotary multi-component system and a related apparatus. The method comprises: extracting a plurality of initial degradation characteristic data according to preset component degradation data based on a preset channel attention network; extracting time sequence degradation characteristic data according to the initial degradation characteristic data based on a preset time sequence attention network, the preset time sequence attention network comprising a preset time sequence weight; performing degradation state classification operation on the time sequence degradation characteristic data by using a preset degradation state classifier to obtain a degradation state data set; performing difference adjustment on characteristic distribution of the degradation state data set based on a domain adversarial network to obtain optimized characteristic data; and performing component life prediction according to the optimized characteristic data by using a preset LSTM prediction model to obtain a life prediction curve.

### CROSS REFERENCE TO RELATED APPLICATIONS

This application claims foreign priority of Chinese Patent Application No. 202211299117.5, filed on Oct. 24, 2022 in the China National Intellectual Property Administration, the disclosures of all of which are hereby incorporated by reference.

### TECHNICAL FIELD

The present application relates to the technical field of device life prediction, and particularly to a life prediction method of a rotary multi-component system and a related apparatus.

### BACKGROUND OF THE PRESENT INVENTION

Remaining life prediction is performed on a device by mining characteristics of device performance degradation data, so that predictive maintenance of the device can be realized effectively and accurately. However, for a multi-component system of precision electronic manufacturing equipment under complex working conditions, due to the extreme complexity and high-speed precision of electronic machining, the degradation of some component not only affects the deformation of electronic materials, but also poses competitive risks to other components and even the whole system. Therefore, the performance degradation of the multi-component system presents multi-element and multi-stage characteristics, resulting in problems such as unbalanced distribution of performance degradation data.

At present, a deep learning model has been used to mine the characteristics of the device performance degradation data. However, most existing intelligent models consider overall characteristics of data when mining deep-seated characteristic information, ignoring or weakening effective local target characteristic information, so that the simulation and reconstruction of a performance degradation process of the device, especially a rotary multi-component system, deviate from actual situations, further leading to an increased error of remaining life prediction of the rotary multi-component system based on a performance degradation state and an increased number of misjudgments.

### SUMMARY OF PRESENT INVENTION

The present application provides a life prediction method of a rotary multi-component system and a related apparatus, so that the technical problem in the prior art that important characteristic information is ignored, leading to a serious error of life prediction result, is solved.

In view of this, a first aspect of the present application provides a life prediction method of a rotary multi-component system, which comprises:
extracting a plurality of initial degradation characteristic data according to preset component degradation data based on a preset channel attention network, wherein the preset component degradation data comprise data with life label and data without life label;
extracting time sequence degradation characteristic data according to the initial degradation characteristic data based on a preset time sequence attention network, wherein the preset time sequence attention network comprises a preset time sequence weight;
performing degradation state classification operation on the time sequence degradation characteristic data by using a preset degradation state classifier to obtain a degradation state data set, wherein the degradation state data set comprises state data with label and state data without label;
performing difference adjustment on characteristic distribution of the degradation state data set based on a domain adversarial network to obtain optimized characteristic data; and
performing component life prediction according to the optimized characteristic data by using a preset LSTM prediction model to obtain a life prediction curve.

Preferably, before the step of extracting the plurality of initial degradation characteristic data according to the preset component degradation data based on the preset channel attention network, the method further comprises the following steps of:
acquiring original degradation data of a target rotary multi-component system;
marking data of a preset proportion in the original degradation data according to a preset rule to obtain the data with life label; and
establishing the preset component degradation data based on unmarked data in the original degradation data and the data with life label.

Preferably, the step of extracting the time sequence degradation characteristic data according to the initial degradation characteristic data based on the preset time sequence attention network, wherein the preset time sequence attention network comprises the preset time sequence weight, comprises:
performing convolution calculation on the initial degradation characteristic data based on a spatial convolution layer in the preset time sequence attention network to obtain multiple segments of spatial characteristic data;
performing weighted average calculation according to the spatial characteristic data based on the preset time sequence weight to obtain multiple segments of channel degradation characteristic data; and
splicing the channel degradation characteristic data according to a time sequence to obtain the time sequence degradation characteristic data.

Preferably, the step of performing the difference adjustment on the characteristic distribution of the degradation state data set based on the domain adversarial network to obtain the optimized characteristic data, comprises:
marking and classifying the state data without label in the degradation state data set through a Gaussian mixture model classifier in the domain adversarial network to obtain proposed classification state data; and
inputting the proposed classification state data and the state data with label in the degradation state data set into a domain adversarial device in the domain adversarial network for data alignment operation to obtain the optimized characteristic data.

A second aspect of the present application provides a life prediction apparatus of a rotary multi-component system, which comprises:
a channel characteristic extraction module configured for extracting a plurality of initial degradation characteristic data according to preset component degradation data based on a preset channel attention network, wherein the preset component degradation data comprise data with life label and data without life label;
a time sequence characteristic extraction module configured for extracting time sequence degradation characteristic data according to the initial degradation characteristic data based on a preset time sequence attention network, wherein the preset time sequence attention network comprises a preset time sequence weight;
a degradation state classification module configured for performing degradation state classification operation on the time sequence degradation characteristic data by using a preset degradation state classifier to obtain a degradation state data set, wherein the degradation state data set comprises state data with label and state data without label;
a data difference adjustment module configured for performing difference adjustment on characteristic distribution of the degradation state data set based on a domain adversarial network to obtain optimized characteristic data; and
a component life prediction module configured for performing component life prediction according to the optimized characteristic data by using a preset LSTM prediction model to obtain a life prediction curve.

Optionally, the apparatus further comprises:
a data acquisition module configured for acquiring original degradation data of a target rotary multi-component system;
a data marking module configured for marking data of a preset proportion in the original degradation data according to a preset rule to obtain the data with life label; and
a data establishment module configured for establishing the preset component degradation data based on unmarked data in the original degradation data and the data with life label.

Preferably, the time sequence characteristic extraction module is specifically configured for:
performing convolution calculation on the initial degradation characteristic data based on a spatial convolution layer in the preset time sequence attention network to obtain multiple segments of spatial characteristic data;
performing weighted average calculation according to the spatial characteristic data based on the preset time sequence weight to obtain multiple segments of channel degradation characteristic data; and
splicing the channel degradation characteristic data according to a time sequence to obtain the time sequence degradation characteristic data.

Preferably, the data difference adjustment module is specifically configured for:
marking and classifying the state data without label in the degradation state data set through a Gaussian mixture model classifier in the domain adversarial network to obtain proposed classification state data; and
inputting the proposed classification state data and the state data with label in the degradation state data set into a domain adversarial device in the domain adversarial network for data alignment operation to obtain the optimized characteristic data.

A third aspect of the present application provides a life prediction device of a rotary multi-component system, wherein the device comprises a processor and a storage;
the storage is configured for storing a program code and transmitting the program code to the processor; and
the processor is configured for executing the life prediction method of the rotary multi-component system in the first aspect based on an instruction in the program code.

A fourth aspect of the present application provides a computer-readable storage medium, wherein the computer-readable storage medium is configured for storing a program code, and the program code is configured for executing the life prediction method of the rotary multi-component system in the first aspect.

It can be seen from the technical solution above that the embodiments of present application have the following advantages:
the present application provides the life prediction method of the rotary multi-component system and a related apparatus, which comprises the following steps of: extracting the plurality of initial degradation characteristic data according to the preset component degradation data based on the preset channel attention network, wherein the preset component degradation data comprise the data with life label and the data without life label; extracting the time sequence degradation characteristic data according to the initial degradation characteristic data based on the preset time sequence attention network, wherein the preset time sequence attention network comprises the preset time sequence weight; performing the degradation state classification operation on the time sequence degradation characteristic data by using the preset degradation state classifier to obtain the degradation state data set, wherein the degradation state data set comprises the state data with label and the state data without label; performing the difference adjustment on the characteristic distribution of the degradation state data set based on the domain adversarial network to obtain the optimized characteristic data; and performing the component life prediction according to the optimized characteristic data by using the preset LSTM prediction model to obtain the life prediction curve.

According to the life prediction method of the rotary multi-component system provided by the present application, different levels of characteristic data of the degradation characteristic data are extracted by the channel attention network and the time sequence attention network, so that global characteristics and local characteristics can be analyzed at the same time. Moreover, the difference adjustment is performed on the characteristic distribution of the degradation state data set through the domain adversarial network, so that the reliability of a prediction effect can be ensured from a data source; and the LSTM prediction model can ensure the accuracy of a prediction result. Therefore, according to the present application, the technical problem in the prior art that important characteristic information is ignored, leading to a serious error of life prediction result, can be solved.

### DESCRIPTION OF THE DRAWINGS

FIG. 1 is a flow chart of a life prediction method of a rotary multi-component system provided by an embodiment of the present application;

FIG. 2 is a schematic structural diagram of a life prediction apparatus of a rotary multi-component system provided by the embodiment of the present application;

FIG. 3 with partial views FIGS. 3A-3C provide a schematic diagram of a characteristic extraction process of a preset channel attention network provided by the embodiment of the present application;

FIG. 4 with partial views FIGS. 4A-4C provide a first schematic diagram of a characteristic extraction process of a preset time sequence attention network provided by the embodiment of the present application;

FIG. 5 is a second schematic diagram of the characteristic extraction process of the preset time sequence attention network provided by the embodiment of the present application;

FIG. 6 is a schematic diagram of a classification process of a preset degradation state classifier provided by the embodiment of the present application;

FIG. 7 is a schematic diagram of a data distribution difference adjustment process of a domain adversarial network provided by the embodiment of the present application;

FIG. 8 is a schematic diagram of a classification operation process of the domain adversarial network provided by the embodiment of the present application;

FIG. 9 is a first schematic diagram of a data adjustment alignment process of the domain adversarial network provided by the embodiment of the present application; and

FIG. 10 is a second schematic diagram of the data adjustment alignment process of the domain adversarial network provided by the embodiment of the present application.

### DETAILED DESCRIPTION OF PREFERRED EMBODIMENTS

In order to make those skilled in the art better understand the solution of the present application, the technical solution in the embodiments of the present application is clearly and completely described with reference to the drawings in the embodiments of the present application. Apparently, the described embodiments are merely some but not all of the embodiments of the present application. Based on the embodiments of the present application, all other embodiments obtained by those of ordinary skills in the art without going through any creative work should fall within the scope of protection of the present application.

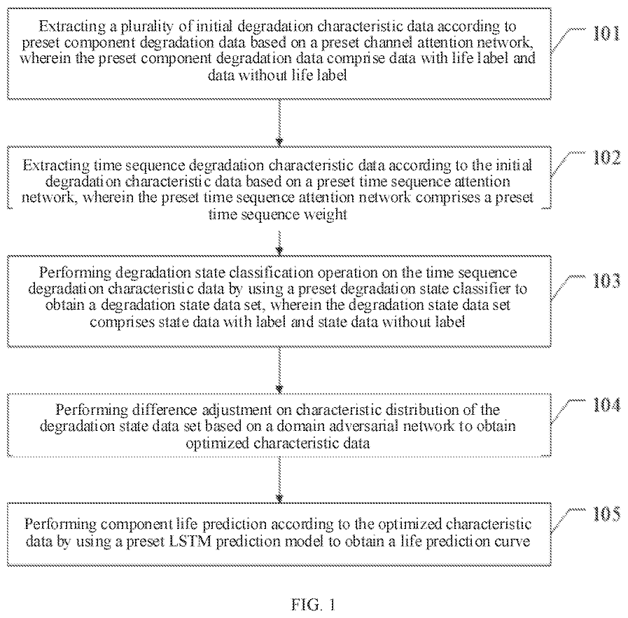

For easy understanding, with reference to FIG. 1, the present application provides a life prediction method of a rotary multi-component system, which comprises the following steps.

In step 101, a plurality of initial degradation characteristic data are extracted according to preset component degradation data based on a preset channel attention network, wherein the preset component degradation data comprise data with life label and data without life label.

The preset component degradation data are obtained in the rotary component system, and one part of the data is marked with a life label and the other part of the data is not marked with the life label. Two data sets in the preset component degradation data are simultaneously input into the preset channel attention network to extract degradation state characteristics in different levels, so that key characteristic information in the degradation data can be retained, and characteristic support is provided for subsequent life prediction.

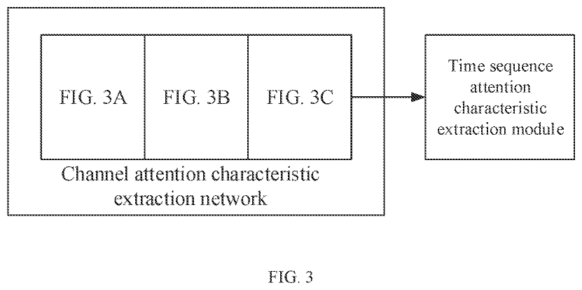

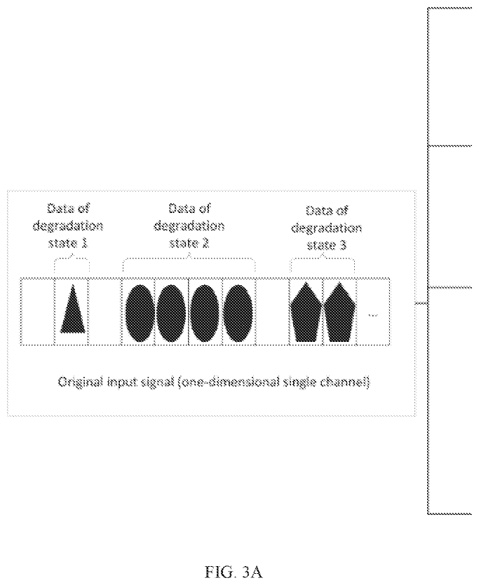

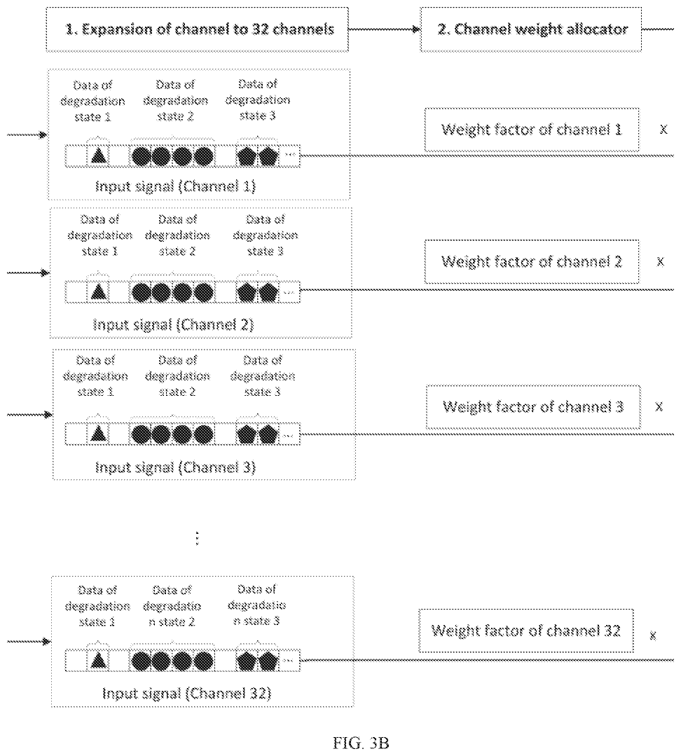

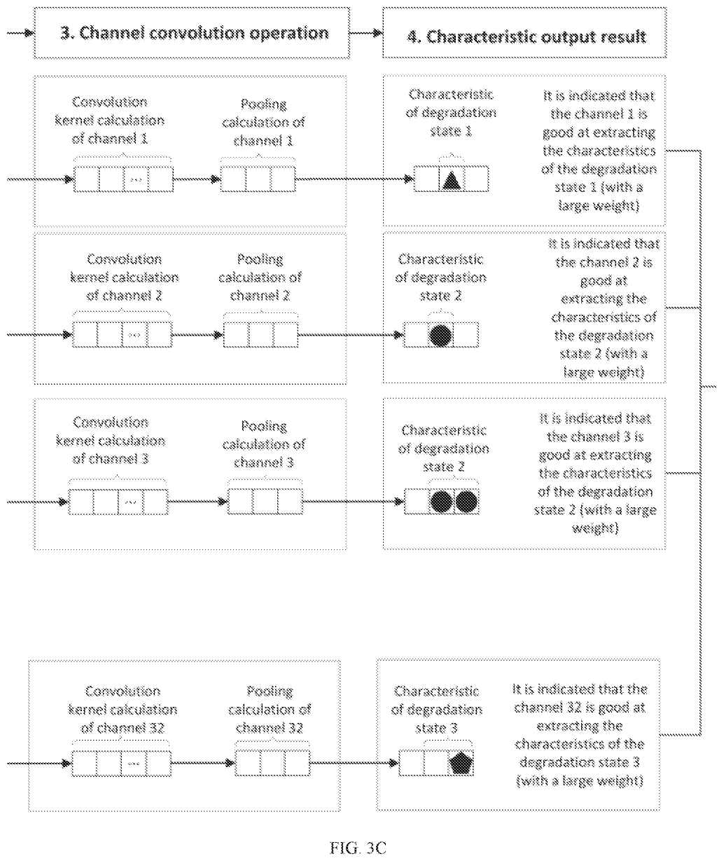

A degradation characteristic data extraction process of the preset channel attention network is shown in FIG. 3, FIG. 3A, FIG. 3B, and FIG. 3C. The preset component degradation data input network is a one-dimensional single-channel form, and a channel attention characteristic extraction module is used to expand a preset component degradation data characteristic extraction channel. A channel weight is set according to a mean value of a convolution kernel of each channel, and the larger the mean value of the convolution kernel is, the greater the channel weight is. The channel with the mean value of the convolution kernel less than a preset mean value will not be concerned. Specific description is as follows:
X₀ represents originally input preset component degradation data, and m represents a characteristic extraction channel. In order to improve an information extraction capability, the characteristic extraction channel m is expanded to k characteristic extraction channels, k=1, 2, 000000, 32, and the characteristic extraction channels are represented by mₖ. For the characteristic extraction channels in mₖ, according to different information extraction capabilities, each channel is given a different weight factor by using a channel weight allocator, the weight factor is represented by qₖ, and a value of qₖ is set according to a mean value of a convolution kernel of a k^{th} channel.

Each characteristic extraction channel is realized by a channel convolution operation module with different parameters. After the channel convolution operation of the preset component degradation data X₀ output of initial degradation characteristic data X₁k weighted by the weight factor qₖ is expressed as follows:

X₁ₖ=fₘ_{ₖ}(X₀)×qₖ, k=1,2, . . . ,32

wherein, fₘ_{ₖ}(X₀) represents an output result after the convolution calculation of the k^{th} characteristic extraction channel mₖ, a plurality of initial degradation characteristic data can be obtained, and what type of degradation state characteristics each channel is good at extracting can be observed from these initial degradation characteristic data.

Further, before the step 101, the method further comprises the following steps of:
acquiring original degradation data of a target rotary multi-component system;
marking data of a preset proportion in the original degradation data according to a preset rule to obtain the data with life label; and
establishing the preset component degradation data based on unmarked data in the original degradation data and the data with life label.

The preset component degradation data comprise marked and unmarked degradation data, and are acquired from a target rotary multi-component system in advance and then obtained by partially marking. A specific marking process is not limited, so that a preset rule may be configured according to actual situations, which will not be repeated herein, and the marking can be realized with reference to the prior art.

In step 102, time sequence degradation characteristic data are extracted according to the initial degradation characteristic data based on a preset time sequence attention network, wherein the preset time sequence attention network comprises a preset time sequence weight.

Further, the step 102 comprises:
performing convolution calculation on the initial degradation characteristic data based on a spatial convolution layer in the preset time sequence attention network to obtain multiple segments of spatial characteristic data;
performing weighted average calculation according to the spatial characteristic data based on the preset time sequence weight to obtain multiple segments of channel degradation characteristic data; and
splicing the channel degradation characteristic data according to a time sequence to obtain the time sequence degradation characteristic data.

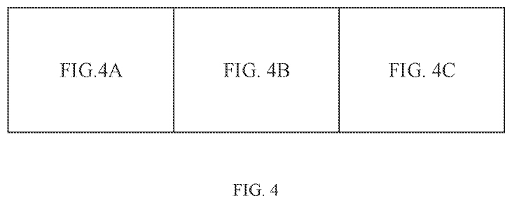

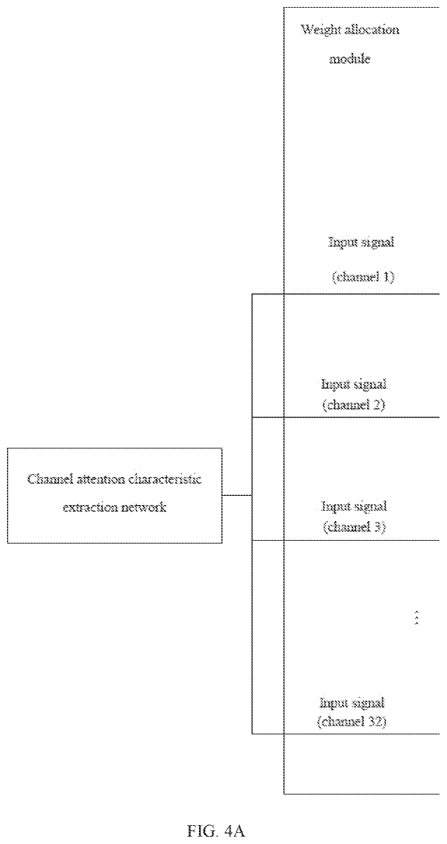

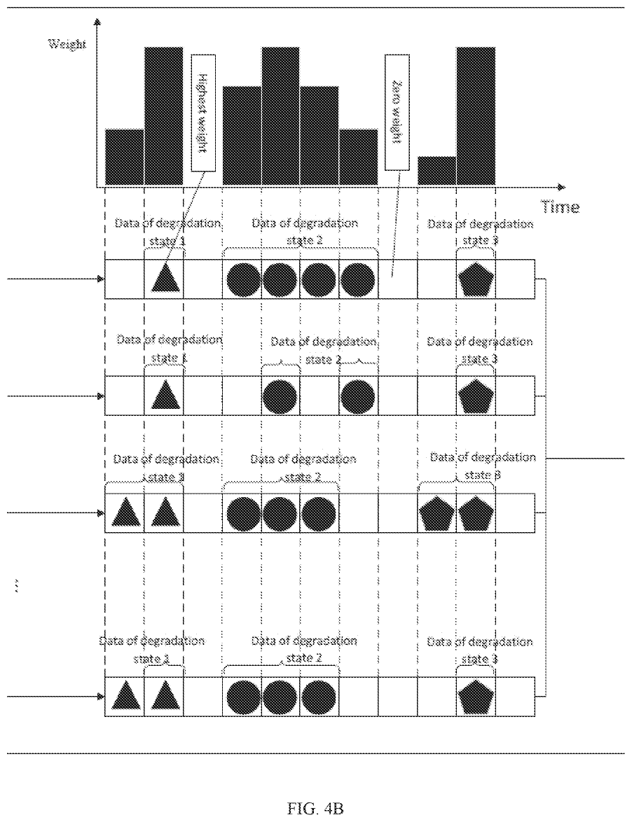

The preset time sequence attention network further extracts time sequence characteristics in the data based on the initial degradation characteristic data. With reference to FIG. 4, FIG. 4A, FIG. 4B, and FIG. 4C, multiple segments of spatial characteristic data may be acquired through the convolution calculation based on the spatial convolution layer, and the preset time sequence weight is set according to a data volume contained in each segment of time sequence characteristic data. A higher weight is given to one segment of time sequence characteristic data with a large data volume, and a lower or zero weight is given to one segment of time sequence characteristic data with a small data volume or no data volume, which means that this segment of data is not concerned. A specific process is as follows.

Input of a time sequence attention characteristic extraction module in the preset time sequence attention network is the initial degradation characteristic data. Any segment of characteristic data X₁k corresponds to one time sequence attention characteristic extraction network respectively, which is namely the spatial convolution layer, and is represented by nₖ (k=1, 2, 000000, 32). After network calculation, each characteristic extraction network nₖ outputs 1 segments of characteristic data, and an i^{th} segment of data is recorded as X₂ₖᵢ, wherein k represents a k^{th} extraction network, and i represents the i^{th} segment of characteristic data. Therefore, a total of k×1 segments of characteristic data are output.

The 1 segments of spatial characteristic data obtained through the convolution calculation are expressed as follows:

X₂ₖᵢ=fₙ_{ₖ}(X₁ₖ), k=1,2, . . . ,32

wherein, fₙ_{ₖ}(X₁ₖ) represents an output result capable of being obtained through the convolution calculation of the k^{th} time sequence attention characteristic network nₖ.

The preset time sequence weight is represented by w₁. For the i^{th} segment of output data X₂ₖᵢ of the characteristic extraction network nₖ, a specific preset time sequence weight value may be configured according to the data volume contained in each segment of characteristic data, which is namely w₁. The i^{th} segment of degradation characteristic data X₂ᵢ integrated with channel information is obtained after weighted average, and the obtained channel degradation characteristic data are expressed as:

$${X}_{2 i} = ( {\sum }_{l = 1}^{l} {X}_{2 ki} \times {w}_{l} ) / 32$$

It should be noted that a value of 1 depends on the data volume output by nₖ.

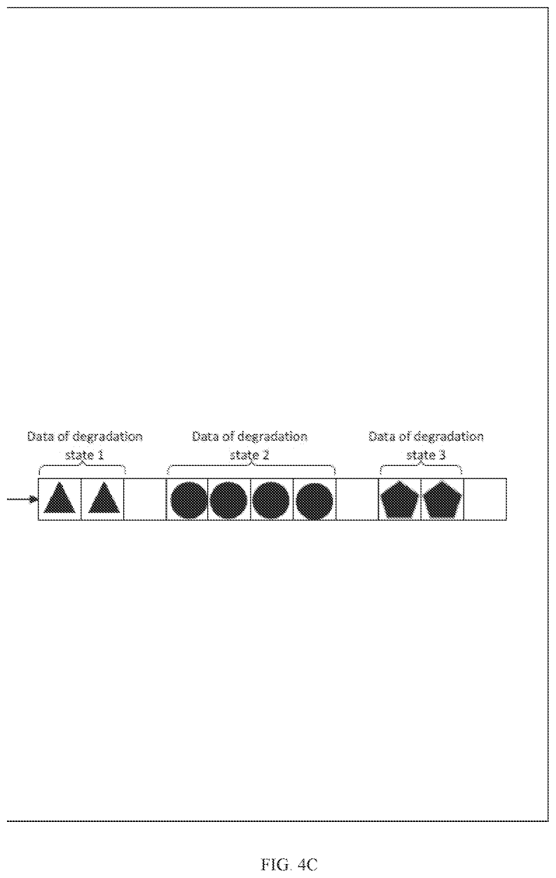

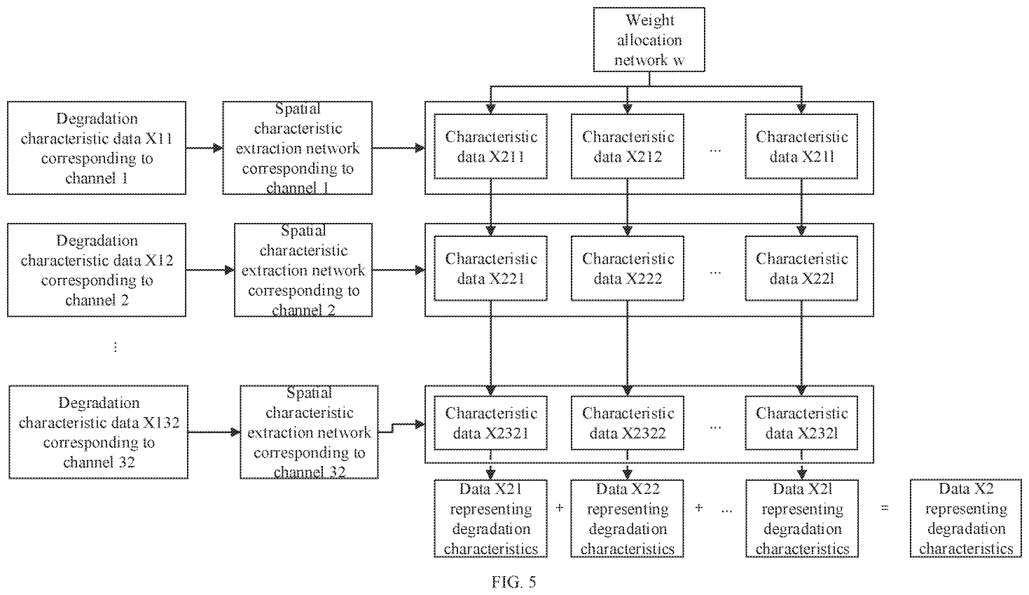

Finally, 1 segments of channel degradation characteristic data are spliced together according to a time sequence to obtain time sequence degradation characteristic data X₂. From analysis of a treatment flow of characteristic data, the whole process may be expressed as shown in FIG. 5.

In step 103, degradation state classification operation is performed on the time sequence degradation characteristic data by using a preset degradation state classifier to obtain a degradation state data set, wherein the degradation state data set comprises state data with label and state data without label.

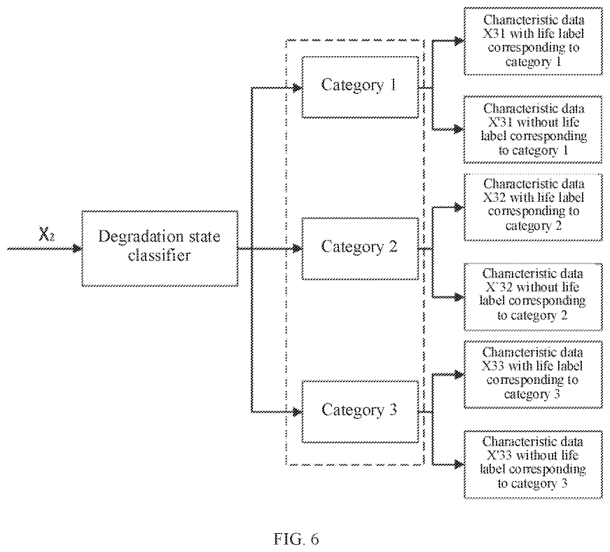

With reference to FIG. 6, the preset degradation state classifier mainly divides the time sequence degradation characteristic data into three different degradation states, comprising bearing outer ring degradation, bearing inner ring degradation and rolling body degradation, and each degradation state comprises corresponding the state data with label and the state data without label. The preset degradation state classifier is a data classifier, and may be selected and set according to actual situations, which is not defined herein, as long as the classifier may complete a specific classification task.

In step 104, difference adjustment is performed on characteristic distribution of the degradation state data set based on a domain adversarial network to obtain optimized characteristic data.

Further, the step 104 comprises:
marking and classifying the state data without label in the degradation state data set through a Gaussian mixture model classifier in the domain adversarial network to obtain proposed classification state data; and
inputting the proposed classification state data and the state data with label in the degradation state data set into a domain adversarial device in the domain adversarial network for data alignment operation to obtain the optimized characteristic data.

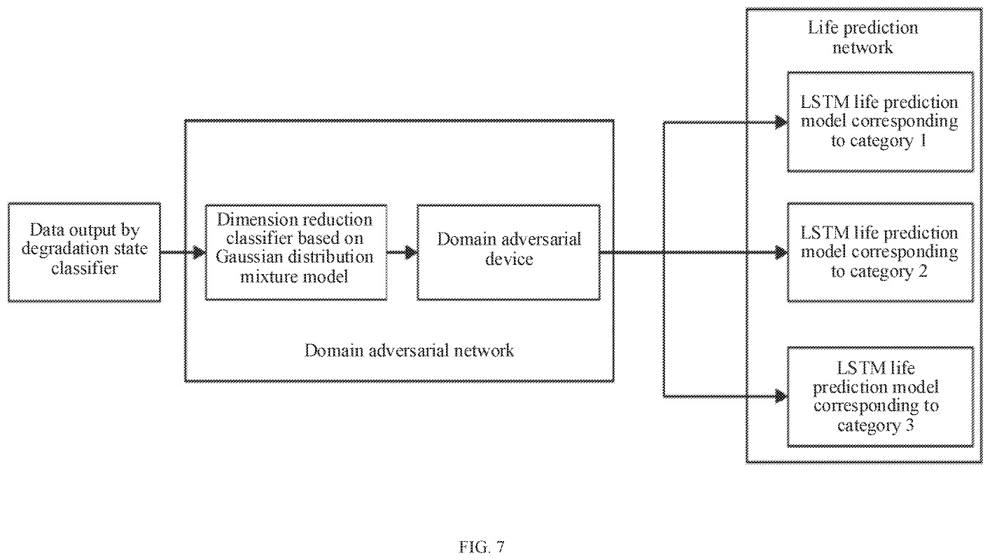

With reference to FIG. 7, the domain adversarial network consists of a classifier based on a Gaussian mixture model and a domain adversarial device, wherein the classifier based on the Gaussian mixture model is a dimension reduction classifier based on a Gaussian distribution mixture model, data may be preliminarily classified based on this classifier, and the domain adversarial device can minimize a distribution difference of data, thus realizing data alignment. A specific process is as follows.

With reference to FIG. 8, in the embodiment, taking labels s1 to s8 as examples, classification operation may be performed according to the labels, which means that label-free data near a corresponding category are classified into the same category and marked with a corresponding life label, and the obtained data are proposed classification state data. The operation may be realized by the Gaussian mixture model classifier.

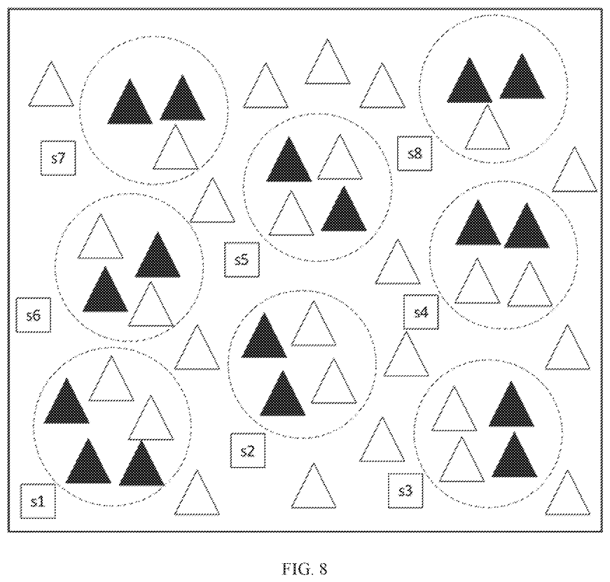

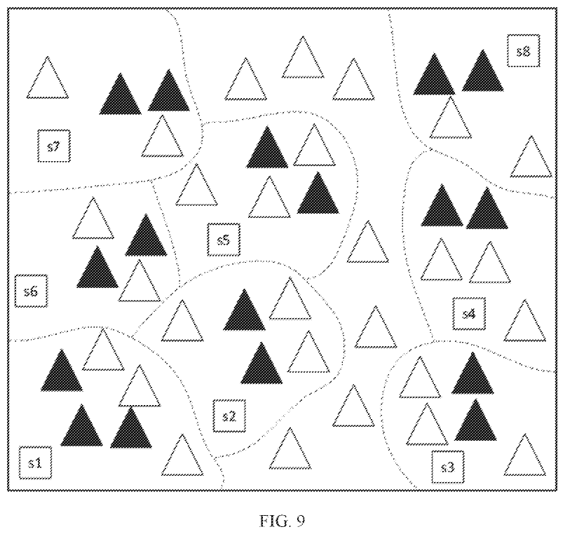

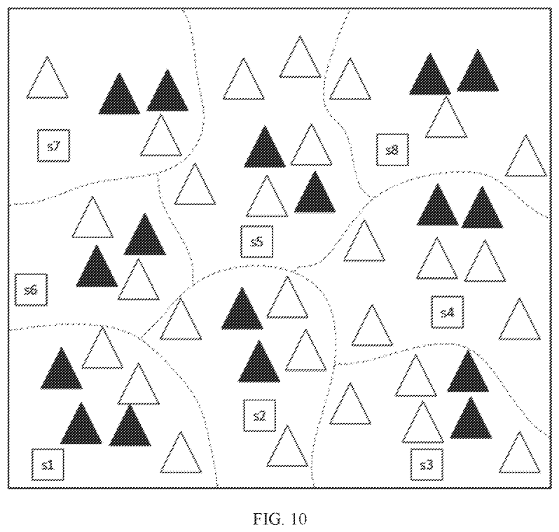

With reference to FIG. 9, the data with the labels are all input into the domain adversarial device for data alignment to minimize a difference between data with the same label, so that the data without the labels outside a category circle are marked through adversarial network training. According to a data distribution property, a range of the category circle in FIG. 8 can be continuously increased, and gradually, more data may be distributed in circles as shown in FIG. 9 and FIG. 10.

In step 105, component life prediction is performed according to the optimized characteristic data by using a preset LSTM prediction model to obtain a life prediction curve.

A time sequence correlation between data can be concerted by the preset LSTM prediction model, so that the predicted life prediction curve is more in line with changing characteristics of actual data, thus being more accurate and reliable. With reference to FIG. 7, the preset LSTM prediction model in the embodiment may perform classification operation on optimized characteristic data classified into categories respectively to obtain corresponding life prediction curves.

According to the life prediction method of the rotary multi-component system provided by the embodiment of the present application, different levels of characteristic data of the degradation characteristic data are extracted by the channel attention network and the time sequence attention network, so that global characteristics and local characteristics can be analyzed at the same time. Moreover, the difference adjustment is performed on the characteristic distribution of the degradation state data set through the domain adversarial network, so that the reliability of a prediction effect can be ensured from a data source; and the LSTM prediction model can ensure the accuracy of a prediction result. Therefore, according to the embodiment of the present application, the technical problem in the prior art that important characteristic information is ignored, leading to a serious error of life prediction result, can be solved.

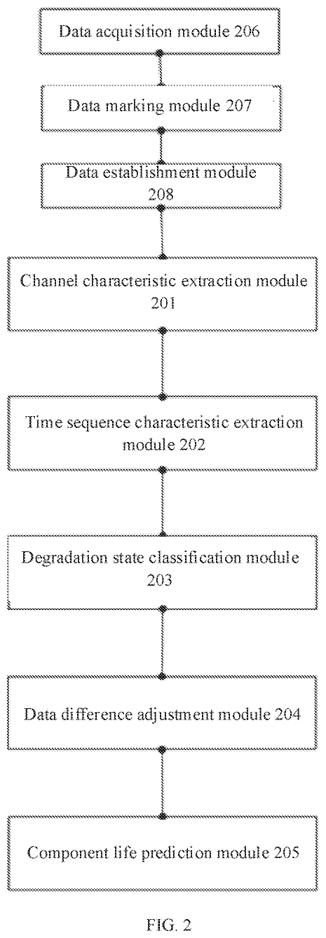

For easy understanding, with reference to FIG. 2, the present application provides a life prediction apparatus of a rotary multi-component system, which comprises:
a channel characteristic extraction module 201 configured for extracting a plurality of initial degradation characteristic data according to preset component degradation data based on a preset channel attention network, wherein the preset component degradation data comprise data with life label and data without life label;
a time sequence characteristic extraction module 202 configured for extracting time sequence degradation characteristic data according to the initial degradation characteristic data based on a preset time sequence attention network, wherein the preset time sequence attention network comprises a preset time sequence weight;
a degradation state classification module 203 configured for performing degradation state classification operation on the time sequence degradation characteristic data by using a preset degradation state classifier to obtain a degradation state data set, wherein the degradation state data set comprises state data with label and state data without label;
a data difference adjustment module 204 configured for performing difference adjustment on characteristic distribution of the degradation state data set based on a domain adversarial network to obtain optimized characteristic data; and
a component life prediction module 205 configured for performing component life prediction according to the optimized characteristic data by using a preset LSTM prediction model to obtain a life prediction curve.

Further, the apparatus further comprises:
a data acquisition module 206 configured for acquiring original degradation data of a target rotary multi-component system;
a data marking module 207 configured for marking data of a preset proportion in the original degradation data according to a preset rule to obtain the data with life label; and
a data establishment module 208 configured for establishing the preset component degradation data based on unmarked data in the original degradation data and the data with life label.

Further, the time sequence characteristic extraction module 202 is specifically configured for:
performing convolution calculation on the initial degradation characteristic data based on a spatial convolution layer in the preset time sequence attention network to obtain multiple segments of spatial characteristic data;
performing weighted average calculation according to the spatial characteristic data based on the preset time sequence weight to obtain multiple segments of channel degradation characteristic data; and
splicing the channel degradation characteristic data according to a time sequence to obtain the time sequence degradation characteristic data.

Further, the data difference adjustment module 204 is specifically configured for:
marking and classifying the state data without label in the degradation state data set through a Gaussian mixture model classifier in the domain adversarial network to obtain proposed classification state data; and
inputting the proposed classification state data and the state data with label in the degradation state data set into a domain adversarial device in the domain adversarial network for data alignment operation to obtain the optimized characteristic data.

The present application further provides a life prediction device of a rotary multi-component system, wherein the device comprises a processor and a storage.

The storage is configured for storing a program code and transmitting the program code to the processor.

The processor is configured for executing the life prediction method of the rotary multi-component system in the method embodiment above based on an instruction in the program code.

The present application further provides a computer-readable storage medium, wherein the computer-readable storage medium is configured for storing a program code, and the program code is configured for executing the life prediction method of the rotary multi-component system in the method embodiment above.

In the several embodiments provided in the present application, it should be understood that the disclosed apparatus and method may be implemented in other ways. For example, the apparatus embodiments described above are only illustrative. For example, the division of the units is only one logical function division. In practice, there may be other division methods. For example, multiple units or components may be combined or integrated into another system, or some features may be ignored or not executed. In addition, the illustrated or discussed mutual coupling or direct coupling or communication connection may be indirect coupling or communication connection through some interfaces, apparatuses or units, and may be in electrical, mechanical or other forms.

The units illustrated as separated parts may be or not be physically separated, and the parts displayed as units may be or not be physical units, which means that the parts may be located in one place or distributed on multiple network units. Some or all of the units may be selected according to actual needs to achieve the object of the solution of the embodiments.

In addition, each functional unit in each embodiment of the present application may be integrated in one processing unit, or each unit may exist alone physically, or two or more units may be integrated in one unit. The integrated units above may be implemented in a form of hardware, or may be implemented in a form of software functional unit.

The integrated units, if being implemented in the form of software functional unit and taken as an independent product to sell or use, may also be stored in one computer-readable storage medium. Based on such understanding, the essence of the technical solution of the present application, or a part contributing to the prior art, or all or a part of the technical solution may be embodied in a form of software product. The computer software product is stored in one storage medium including a number of instructions such that a computer device (which may be a personal computer, a server, or a network device, etc.) executes all or a part of steps of the method in the embodiments of the present application. Moreover, the foregoing storage medium comprises: various media capable of storing the program code, such as a USB disk, a mobile hard disk, a Read-Only Memory (ROM), a Random Access Memory (RAM), a magnetic disk or an optical disk.

As described above, the embodiments above are only used to illustrate the technical solution of the present application, and are not intended to limit the present application. Although the present application has been described in detail with reference to the above-mentioned embodiments, those of ordinary skills in the art should understand that: the technical solution recorded in the above-mentioned embodiments can still be modified, or equivalent substitutions can be made to a part of the technical features in the embodiments. However, these modifications or substitutions should not depart from the spirit and scope of the technical solution of the embodiments of the present application.

We claim:

1. A life prediction method of a rotary multi-component system, comprising the following steps of:
extracting a plurality of initial degradation characteristic data according to preset component degradation data based on a preset channel attention network, wherein the preset component degradation data comprise data with life label and data without life label;
extracting time sequence degradation characteristic data according to the initial degradation characteristic data based on a preset time sequence attention network, wherein the preset time sequence attention network comprises a preset time sequence weight;
performing degradation state classification operation on the time sequence degradation characteristic data by using a preset degradation state classifier to obtain a degradation state data set, wherein the degradation state data set comprises state data with label and state data without label;
performing difference adjustment on characteristic distribution of the degradation state data set based on a domain adversarial network to obtain optimized characteristic data; and
performing component life prediction according to the optimized characteristic data by using a preset LSTM prediction model to obtain a life prediction curve.

2. The life prediction method of the rotary multi-component system according to claim 1, wherein before the step of extracting the plurality of initial degradation characteristic data according to the preset component degradation data based on the preset channel attention network, the method further comprises the following steps of:
acquiring original degradation data of a target rotary multi-component system;
marking data of a preset proportion in the original degradation data according to a preset rule to obtain the data with life label; and
establishing the preset component degradation data based on unmarked data in the original degradation data and the data with life label.

3. The life prediction method of the rotary multi-component system according to claim 1, wherein the step of extracting the time sequence degradation characteristic data according to the initial degradation characteristic data based on the preset time sequence attention network, wherein the preset time sequence attention network comprises the preset time sequence weight, comprises:
performing convolution calculation on the initial degradation characteristic data based on a spatial convolution layer in the preset time sequence attention network to obtain multiple segments of spatial characteristic data;
performing weighted average calculation according to the spatial characteristic data based on the preset time sequence weight to obtain multiple segments of channel degradation characteristic data; and
splicing the channel degradation characteristic data according to a time sequence to obtain the time sequence degradation characteristic data.

4. The life prediction method of the rotary multi-component system according to claim 1, wherein the step of performing the difference adjustment on the characteristic distribution of the degradation state data set based on the domain adversarial network to obtain the optimized characteristic data, comprises:
marking and classifying the state data without label in the degradation state data set through a Gaussian mixture model classifier in the domain adversarial network to obtain proposed classification state data; and
inputting the proposed classification state data and the state data with label in the degradation state data set into a domain adversarial device in the domain adversarial network for data alignment operation to obtain the optimized characteristic data.

5. A life prediction apparatus of a rotary multi-component system, comprising:
a channel characteristic extraction module configured for extracting a plurality of initial degradation characteristic data according to preset component degradation data based on a preset channel attention network, wherein the preset component degradation data comprise data with life label and data without life label;
a time sequence characteristic extraction module configured for extracting time sequence degradation characteristic data according to the initial degradation characteristic data based on a preset time sequence attention network, wherein the preset time sequence attention network comprises a preset time sequence weight;
a degradation state classification module configured for performing degradation state classification operation on the time sequence degradation characteristic data by using a preset degradation state classifier to obtain a degradation state data set, wherein the degradation state data set comprises state data with label and state data without label;
a data difference adjustment module configured for performing difference adjustment on characteristic distribution of the degradation state data set based on a domain adversarial network to obtain optimized characteristic data; and
a component life prediction module configured for performing component life prediction according to the optimized characteristic data by using a preset LSTM prediction model to obtain a life prediction curve.

6. The life prediction apparatus of the rotary multi-component system according to claim 5, further comprising:
a data acquisition module configured for acquiring original degradation data of a target rotary multi-component system;
a data marking module configured for marking data of a preset proportion in the original degradation data according to a preset rule to obtain the data with life label; and
a data establishment module configured for establishing the preset component degradation data based on unmarked data in the original degradation data and the data with life label.

7. The life prediction apparatus of the rotary multi-component system according to claim 5, wherein the time sequence characteristic extraction module is specifically configured for:
performing convolution calculation on the initial degradation characteristic data based on a spatial convolution layer in the preset time sequence attention network to obtain multiple segments of spatial characteristic data;
performing weighted average calculation according to the spatial characteristic data based on the preset time sequence weight to obtain multiple segments of channel degradation characteristic data; and
splicing the channel degradation characteristic data according to a time sequence to obtain the time sequence degradation characteristic data.

8. The life prediction apparatus of the rotary multi-component system according to claim 5, wherein the data difference adjustment module is specifically configured for:
marking and classifying the state data without label in the degradation state data set through a Gaussian mixture model classifier in the domain adversarial network to obtain proposed classification state data; and
inputting the proposed classification state data and the state data with label in the degradation state data set into a domain adversarial device in the domain adversarial network for data alignment operation to obtain the optimized characteristic data.

9. A life prediction device of a rotary multi-component system, wherein the device comprises a processor and a storage;
the storage is configured for storing a program code and transmitting the program code to the processor; and
the processor is configured for executing the life prediction method of the rotary multi-component system according to claim 1 based on an instruction in the program code.
